(19) United States
(12) Patent Application Publication
(10) Pub. No.: US 2024/0344286 A1
(43) Pub. Date: Oct. 17, 2024

(54) Cat Litter Scoop

(71) Applicant: Xiuwei BAO, ZHEJIANG PROVINCE (CN)

(72) Inventor: Xiuwei BAO, ZHEJIANG PROVINCE (CN)

(21) Appl. No.: 18/233,902

(22) Filed: Aug. 15, 2023

(30) Foreign Application Priority Data
Apr. 14, 2023 (CN) 2023208350474

(51) Int. Cl. E01H 1/12

(52) U.S. Cl. CPC E01H 1/1206; A01K 1/011

(57) ABSTRACT

A cat litter scoop having a scoop body and a scoop handle connected to the scoop body; the scoop body includes a first scoop mechanism, a second scoop mechanism, and a board strip connecting the two; the first scoop mechanism includes first metal rods parallel to each other; a first filtering gap is formed between every two adjacent first metal rods; the second scoop mechanism includes a second metal rods in a U-shape; sizes of the second metal rods increase sequentially from center to periphery of the cat litter scoop; a second filtering gap is formed between every two adjacent second metal rods; a size of the second filtering gaps is larger than a size of the first filtering gaps. Clumped cat litter that cannot pass through the first filtering gaps can pass through the larger second filtering gaps so that cat litter of different sizes can be filtered.

### FIELD OF THE INVENTION

The present invention relates to the field of cat litter scoops, and more particularly relates to a cat litter scoop.

### BACKGROUND OF THE INVENTION

Cat litter is a product used by cat owners for cats to bury feces and urine, which has good water absorption and is usually used together with a cat litter box; after pouring an appropriate amount of cat litter into the cat litter box, a trained cat will walk into the cat litter box to excrete; when a cat litter scoop is filled with both cat litter and cat waste, as clumps of cat waste are larger in size than particles of cat litter, the cat litter scoop is usually provided with gaps for the cat litter to fall through and filtering out the cat waste, which is convenient for removing the cat waste from the cat litter.

Upon searching, a Chinese patent CN113207707A has disclosed an electric cat litter scoop, comprising a handle part, a scoop head connected to a front end of the handle part, and an electric drive mechanism to drive the scoop head to vibrate; said disclosed patent achieves filtering of cat litter with vibration in a relatively average frequency of the cat litter scoop driven by electric and mechanical energy; however, said disclosed patent contains drawbacks, including litter filtering gaps of the scoop head with a fixed size, which are not capable of filtering cat litter particles in different sizes and lead to inability to filter clumped cat litter, and thus need to be improved.

### BRIEF SUMMARY OF THE INVENTION

It is an object of the present invention to solve the above drawbacks of the prior art by providing a cat litter scoop.

To attain the above object, the present invention provides the following technical solution:

A cat litter scoop, comprising a scoop body and a scoop handle connected to the scoop body; the scoop body comprises a first scoop mechanism, a second scoop mechanism, and a board strip connecting the first scoop mechanism and the second scoop mechanism; the first scoop mechanism comprises a plurality of first metal rods which are parallel to each other; a first filtering gap is formed between every two adjacent first metal rods; the second scoop mechanism comprises a plurality of second metal rods each in a U-shape and in different sizes; sizes of the second metal rods increase sequentially from a center to a periphery of the cat litter scoop; a second filtering gap is formed between every two adjacent second metal rods; a size of the second filtering gaps is larger than a size of the first filtering gaps.

Preferably, a spacing distance between every two adjacent first metal rods is from 0.4 cm to 0.8 cm.

Preferable, a spacing distance between every two adjacent second metal rods is from 0.8 cm to 1.2 cm.

Preferably, each first metal rod comprises an inclined section and a horizontal section; an obtuse angle is formed between the inclined section and the horizontal section of each first metal rod.

Preferably, a plurality of first rod slots and second rod slots are formed on the board strip; a free end of the horizontal section of each first metal rod is in welding connection inside a corresponding first rod slot; each end of each second metal rod is in welding connection inside a corresponding second rod slot.

Preferably, the present invention further comprises an end rod; a free end of the inclined section of each first metal rod is in welding connection with the end rod.

Preferably, first reinforcing rods are in welding connection between every two adjacent second metal rods.

Preferably, the present invention further comprises a surrounding structure around the scoop body; the surrounding structure comprises a plurality of surrounding rods each in a U-shape; two ends of each surrounding rod are in welding connection with outermost first metal rods on two sides of the cat litter scoop respectively.

Preferably, second reinforcing rods are in welding connection between every two adjacent surrounding rods.

Preferably, a hanging ring is in welding connection with the surrounding rods.

In comparison to the prior art, the beneficial effects of the present invention are as follows:

Firstly, the present invention comprises the first filtering gaps and the second filtering gaps, wherein a size of the second filtering gaps is larger than a size of the first filtering gaps; when the first filtering gaps are not able to filter out the clumps of cat litter, the second filtering gaps with a larger size are convenient for cat litter to fall through. Also, the present invention is capable of filtering cat litter with different particle sizes.

Secondly, the board strip ensures a good appearance and manufacturing efficiency of the present invention, which allows iron wires to be arranged with different spacing distances on the cat litter scoop, thus providing a good experience of quick filtering when scooping cat litter.

### BRIEF DESCRIPTION OF THE DRAWINGS

FIG. 1 shows a first perspective view of the present invention;

FIG. 2 shows a second perspective view of the present invention;

FIG. 3 shows a top view of the present invention;

FIG. 4 shows a perspective view of the surrounding structure of the present invention;

FIG. 5 shows a perspective view of the first scoop mechanism of the present invention;

FIG. 6 shows a perspective view of the board strip of the present invention.

As illustrated in the figures: 10 denotes the first metal rods; 100 denotes the inclined sections; 101 denotes the horizontal sections; 11 denotes the end rod; 20 denotes the second metal rods; 21 denotes the first reinforcing rods; 3 denotes the board strip; 30 denotes the first rod slots; 31 denotes the second rod slots; 40 denotes the surrounding rods; 41 denotes the second reinforcing rods; 50 denotes the scoop handle; 51 denotes the connecting rods; 6 denotes the hanging ring.

### DETAILED DESCRIPTION OF THE INVENTION

The technical solutions of the embodiments of the present invention are clearly and fully described below with reference to the accompanying drawings. It is obviously that the embodiments described herein are only some, but not all embodiments of the present invention. All other embodiments obtained by those skilled in the art based on the embodiments of the present invention without inventive efforts should fall within the protection scope of the present invention.

In the description of the present invention, it should be understood that orientations or positional relationships indicated by the terms “center”, “longitudinal”, “horizontal”, “lengthwise”, “widthwise”, “thickness”, “upper”, “lower”, “front”, “rear”, “left”, “right”, “vertical”, “horizontal”, “top”, “bottom”, “inner”, “outer”, “clockwise”, “counterclockwise” and the like are orientations or positional relationships as shown in the drawings, and are only for the purpose of facilitating and simplifying the description of the present invention instead of indicating or implying that devices or elements indicated must have particular orientations, or be constructed and operated in the particular orientations. Such terms shall not be construed as limiting the present invention.

In the embodiments of the present invention, unless otherwise explicitly specified and limited, the terms such as “mount”, “arrange”, “sleeve”, “connect” and the like should be interpreted in a broad sense. For example, it may be a fixed connection, a detachable connection or integration; may be a mechanical connection or an electric connection; or may be a direct connection, an indirect connection by means of an intermediate, an internal interconnection of two elements or an interaction of two elements. For those of ordinary skill in the art, the specific meanings of the above terms in the present invention can be construed according to specific situations.

In addition, the terms “first” and “second” are only for the purpose of description, and may not be construed as indicating or implying the relative importance or implicitly indicating the number of technical features indicated. Thus, features defined by “first” and “second” may explicitly or implicitly include one or more of that feature. In the description of the present invention, “plurality” refers to two or more, unless otherwise explicitly and specifically defined.

The present invention provides the following technical solution:

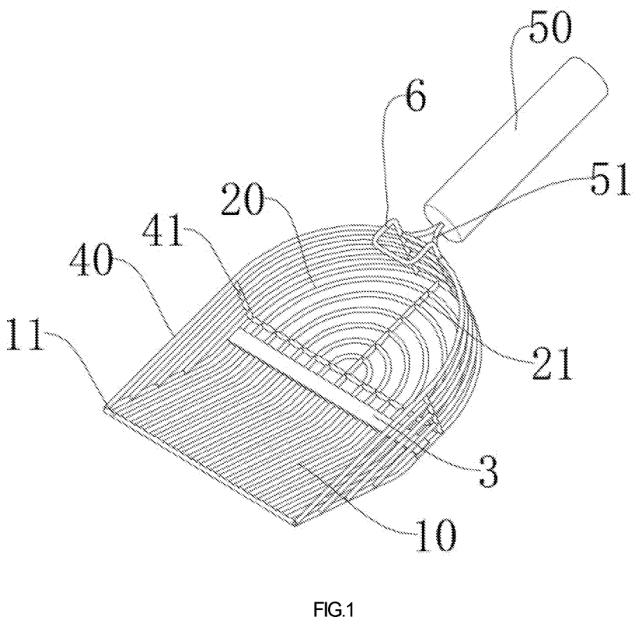

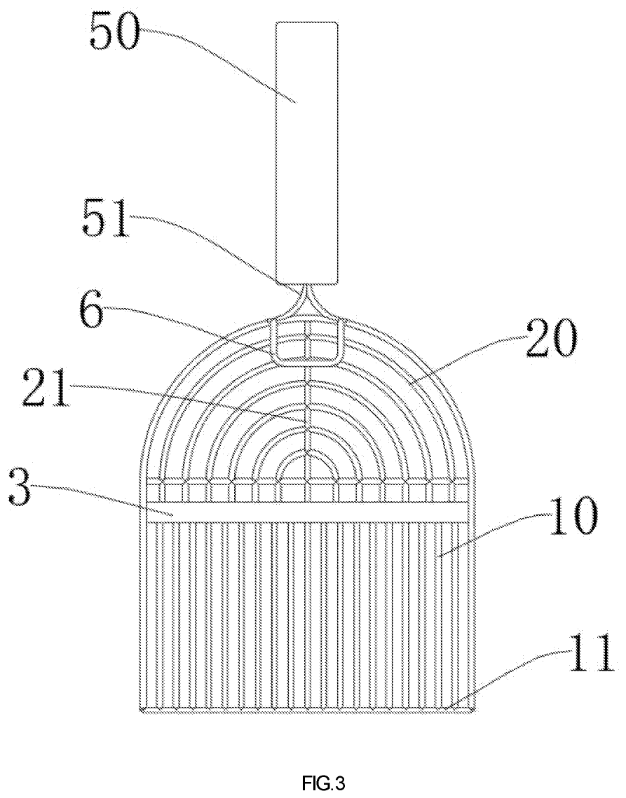

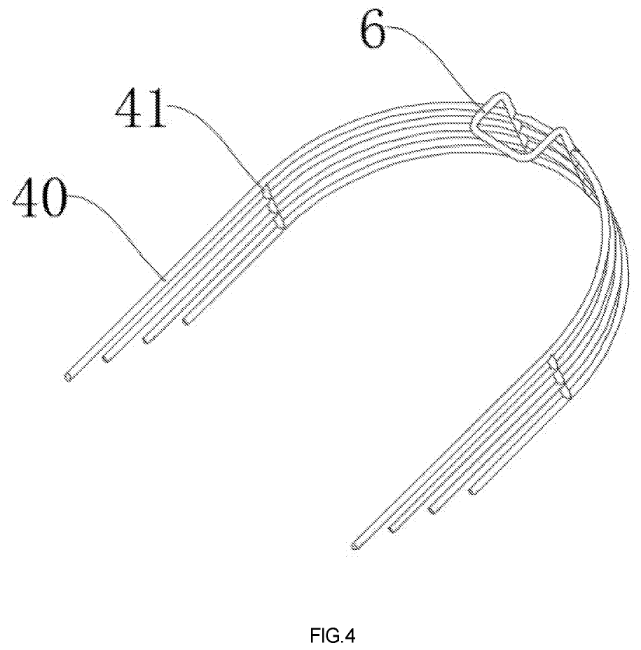

A cat litter scoop, as illustrated in FIGS. 1-6, comprising a scoop body and a scoop handle 50 connected to the scoop body; the scoop body comprises a first scoop mechanism, a second scoop mechanism and a board strip 3 connecting the first scoop mechanism and the second scoop mechanism.

It should be noted that, cat litter is a product used by cat owners for cats to bury feces and urine, which has good water absorption and is usually used together with a cat litter box; after pouring an appropriate amount of cat litter into the cat litter box, a trained cat will walk into the cat litter box to excrete; when a cat litter scoop is filled with both cat litter and cat waste, as clumps of cat waste are larger in size than particles of cat litter, the cat litter scoop is usually provided with gaps for the cat litter to fall through and filtering out the cat waste, which is convenient for removing the cat waste from the cat litter.

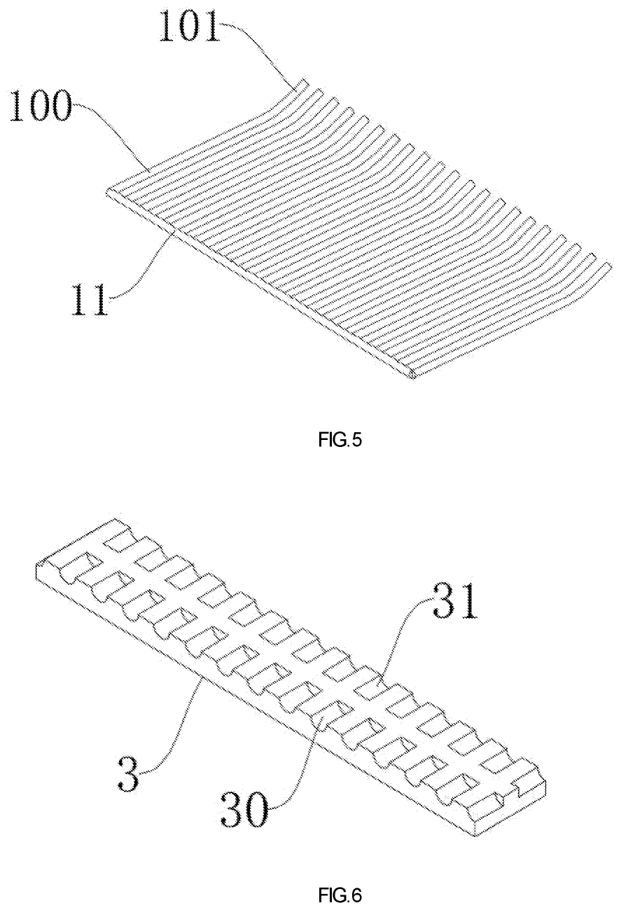

As illustrated in FIG. 5, the first scoop mechanism comprises a plurality of first metal rods 10 which are parallel to each other; a first filtering gap is formed between every two adjacent first metal rods 10; after filling the first scoop mechanism with both cat litter and cat waste, the cat litter fall through the first filtering gaps, so as to filter out the cat waste.

Specifically, a spacing distance between every two adjacent first metal rods 10 is from 0.4 cm to 0.8 cm, namely 0.4 cm, 0.5 cm, 0.6 cm, 0.7 cm or 0.8 cm; 0.6 cm is preferred in the present invention.

Specifically, each first metal rod 10 comprises an inclined section 100 and a horizontal section 101; an obtuse angle is formed between the inclined section 100 and the horizontal section 101 of each first metal rod 10; with this design, it is easier to insert the first scoop mechanism into the cat litter, and is more convenient to scoop the cat litter.

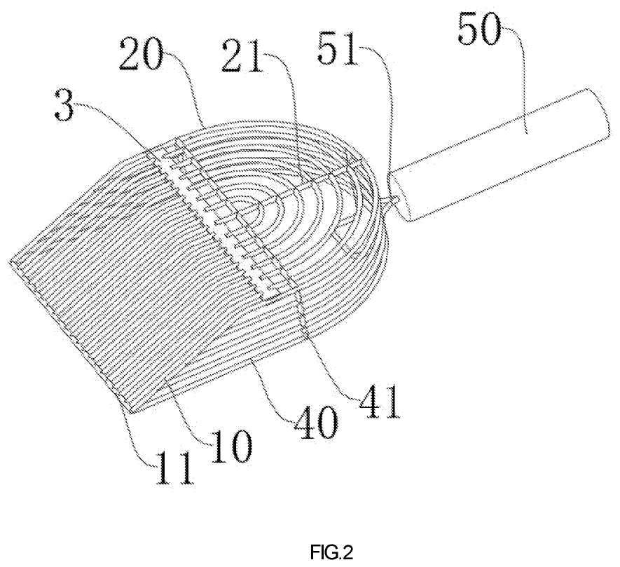

To improve stability of the first scoop mechanism, as illustrated in FIG. 1, FIG. 2 and FIG. 5, the present invention further comprises an end rod 11; a free end of the inclined section 100 of each first metal rod 10 is in welding connection with the end rod 11; by connecting the free end of the inclined section 100 of each first metal rod 10 with the end rod 11, an overall solidity of the first scoop mechanism is improved.

The second scoop mechanism comprises a plurality of second metal rods 20 each in a U-shape; the second metal rods 20 are provided in different sizes; sizes of the second metal rods 20 increase sequentially from a center to a periphery of the cat litter scoop; specifically, arrangement of the second metal rods 20 is illustrated in FIGS. 1-3, wherein a second filtering gap is formed between every two adjacent second metal rods 20.

After filling the second scoop mechanism with both cat litter and cat waste, the cat litter fall through the second filtering gaps, and the cat waste remain, which is convenient for removing the cat waste from the cat litter.

Furthermore, in the present invention, the first scoop mechanism is arranged in front of the second scoop mechanism; cat litter being scooped will first pass through the first scoop mechanism, and then pass through the second scoop mechanism; a size of the second filtering gaps is larger than a size of the first filtering gaps; as clumps of cat litter may be formed after a cat excreted, when the first filtering gaps are not able to filter out the clumps of cat litter, the second filtering gaps with a larger size are convenient for clumped cat litter to fall through. Also, the present invention is capable of filtering cat litter with different particle sizes sold on the market.

A spacing distance between every two adjacent second metal rods 20 is from 0.8 cm to 1.2 cm, namely 0.8 cm, 0.9 cm, 1 cm, 1.1 cm or 1.2 cm; 1 cm is preferred in the present invention.

When the second scoop mechanism is filled with cat litter, the second scoop mechanism is loaded; to improve stability of the second metal rods 20; first reinforcing rods 21 are in welding connection between every two adjacent second metal rods 20, which improves stability of connection between the second metal rods 20.

A plurality of first rod slots 30 and second rod slots 31 are formed on the board strip 3; a free end of the horizontal section 101 of each first metal rod 10 is in welding connection inside a corresponding first rod slot 30; each end of each second metal rod 20 is in welding connection inside a corresponding second rod slot 31.

In the present invention, except for the scoop handle 50, all components are made of iron wires, which are connected with each other by welding connection of iron wires; as iron wires are relatively thin, it is only technically possible to provide an equal spacing distance between the iron wires on a same surface of the cat litter scoop. For instance, a spacing distance of all iron wire of a same surface is either 1 cm or 0.6 cm, but it is not able to provide on a same surface with a spacing distance of 0.6 cm at a front part and a spacing distance of 1 cm at a rear part. Therefore, the present invention comprises the board strip 3 with a certain width, so as to provide the metal rods of the cat little scoop with a spacing distance of 0.6 cm for a front part, and 1 cm for a rear part, thereby ensuring that iron wires with different spacing distances are in welding connection on a same scooping surface, while maintaining a good appearance and manufacturing efficiency.

The board strip 3 ensures a good appearance and manufacturing efficiency of the present invention, which allows iron wires to be arranged with different spacing distances on the cat litter scoop, thus providing a good experience of quick filtering when scooping cat litter, while solving the problem of tiny clumps spilling out of the scoop.

The present invention further provides a surrounding structure around the scoop body; the surrounding structure comprises a plurality of surrounding rods 40 each in a U-shape; the surrounding rods 40 are arranged with an equal spacing distance successively from top to bottom; two ends of each surrounding rod 40 are in welding connection with outermost first metal rods 10 on two sides of the cat litter scoop respectively; specifically, each end of each surrounding rod 40 is in welding connection with the inclined section 100 of a corresponding first metal rod 10.

Second reinforcing rods 41 are in welding connection between every two adjacent surrounding rods 40, so as to improve stability of the surrounding rods 40.

A hanging ring 6 is in welding connection with the surrounding rods 40; when not in use, the cat litter scoop can be hanged up with the hanging ring 6.

Connecting rods 51 are in welding connection with a rear side of an uppermost surrounding rod 40; the connecting rods 51 are fixedly connected with the scoop handle 50.

The fundamental mechanism, main characteristics and beneficial effects of the present invention are illustrated and described above. It should be understood by those skilled in the art that, the present invention is not limited to the above embodiment; the embodiment describes in the specification is only the preferred embodiment of the present invention, which is not intended to set a limit to the protection scope of the present invention. All variations and modifications without departing from the essence of the present invention shall also fall within the protection scope of the present invention as defined by the appended claims and the equivalents thereof.

What is claimed is:

1. A cat litter scoop, comprising a scoop body and a scoop handle connected to the scoop body, wherein the scoop body comprises a first scoop mechanism, a second scoop mechanism, and a board strip connecting the first scoop mechanism and the second scoop mechanism; the first scoop mechanism comprises a plurality of first metal rods which are parallel to each other; a first filtering gap is formed between every two adjacent first metal rods; the second scoop mechanism comprises a plurality of second metal rods each in a U-shape and in different sizes; sizes of the second metal rods increase sequentially from a center to a periphery of the cat litter scoop; a second filtering gap is formed between every two adjacent second metal rods; a size of the second filtering gaps is larger than a size of the first filtering gaps.

2. The cat litter scoop of claim 1, wherein a spacing distance between every two adjacent first metal rods is from 0.4 cm to 0.8 cm.

3. The cat litter scoop of claim 1, wherein a spacing distance between every two adjacent second metal rods is from 0.8 cm to 1.2 cm.

4. The cat litter scoop of claim 1, wherein each first metal rod comprises an inclined section and a horizontal section; an obtuse angle is formed between the inclined section and the horizontal section of each first metal rod.

5. The cat litter scoop of claim 4, wherein a plurality of first rod slots and second rod slots are formed on the board strip; a free end of the horizontal section of each first metal rod is in welding connection inside a corresponding first rod slot; each end of each second metal rod is in welding connection inside a corresponding second rod slot.

6. The cat litter scoop of claim 4, further comprising an end rod; a free end of the inclined section of each first metal rod is in welding connection with the end rod.

7. The cat litter scoop of claim 1, wherein first reinforcing rods are in welding connection between every two adjacent second metal rods.

8. The cat litter scoop of claim 1, further comprising a surrounding structure around the scoop body; the surrounding structure comprises a plurality of surrounding rods each in a U-shape; two ends of each surrounding rod are in welding connection with outermost first metal rods on two sides of the cat litter scoop respectively.

9. The cat litter scoop of claim 8, wherein second reinforcing rods are in welding connection between every two adjacent surrounding rods.

10. The cat litter scoop of claim 9, wherein a hanging ring is in welding connection with the surrounding rods.
